(19) United States
(12) Patent Application Publication
(10) Pub. No.: US 2006/0278059 A1
(43) Pub. Date: Dec. 14, 2006

(54) Combination end pin and output jack for musical instruments

(76) Inventor: Howard Keith Gipson, Trinidad, CO (US)

Correspondence Address: Howard Keith Gipson, 31989 Hwy 12, Trinidad, CO, 81082, US

(21) Appl. No.: 11/445,725

(22) Filed: Jun. 2, 2006

Related U.S. Application Data
(60) Provisional application No. 60/688,778, filed on Jun. 9, 2005.

(51) Int. Cl. G10D 3/12

(52) U.S. Cl. 84/302

(57) ABSTRACT

An end pin/electrical output jack assembly which can be fitted (with no modification to the instrument) to acoustic guitars, mandolins, violins, and other musical instruments which are equipped with a traditional tapered pin type of end pin inserted into a tapered hole in the instrument. Also the use of a tapered hole to receive and/or retain an electrical output jack assembly or a combination end pin and output jack on/in a musical instrument.

### CROSS REFERENCE TO RELATED APPLICATIONS

Provisional patent application U.S. 60/688,778

### BACKGROUND OF INVENTION

1. Field of the Invention

This invention relates to end pins, electrical output jacks, and strap retainers for acoustic musical instruments.

2. Description of Prior Art

Acoustic instruments of the guitar, mandolin, and violin types traditionally have been equipped with a tapered end pin which is fitted into a matching taper hole in the end block of the instrument. In the case of acoustic guitars this end pin is used as a means of attaching a shoulder strap. Violins and some other instruments use this end pin as a means to secure a tailpiece thereby anchoring the strings.

As electric pickups of a wide variety of types have become popular, it has become necessary to provide some means of attaching an electrical cable to the instrument to transmit the output signal from the pickup to an amplifier or other device. This connection is usually made via a jack type connector on the instrument and a matching plug type connector on the cable. Prior art methods require altering the instrument by drilling holes or the use of clamping devices to retain the output jack connector. The various drilling methods by their very nature irreversibly alter and possibly destroy the structural integrity and intrinsic value of the instrument, while the use of clamp on type attachments can cause both cosmetic and structural damage to the instrument.

### BRIEF SUMMARY OF THE INVENTION

In the present invention it is recognized that it is desirable to provide a device and method to mount an output jack without modification to the musical instrument. This device and method will prevent loss of intrinsic value and/or possible structural or cosmetic damage to the instrument.

The present invention provides a combination end pin and output jack that will mate with the existing tapered end pin hole, on instruments so equipped. This will allow the instrument to be fitted with the necessary electrical connections for use with a pickup without modification, thus maintaining the integrity and intrinsic value of the instrument.

More particularly, the present invention provides an end pin made of a suitable material and shape to supply all of the functions of a traditional end pin and include all the required components of the output jack enclosed within.

It is to be understood that the description and examples of the present invention provided herein are not by way of limitation and various modifications within the scope of the present invention will occur to those skilled in the art upon reading these disclosures.

### BRIEF DESCRIPTION OF THE SEVERAL VIEWS OF THE DRAWINGS

FIG. 1 is a cutaway view of a representative embodiment of a combination end pin/output jack.

FIG. 2 is a perspective view of a representative embodiment of a combination end pin/output jack

FIG. 3 is a cutaway view of a representative acoustic guitar 10 illustrating the tapered endpin hole 14 traditionally used to receive the instrument's endpin.

FIG. 4 is a cutaway view showing a representative embodiment of a combination end pin/output jack assembly 5 of the present invention in a typical installment for an acoustic guitar 10.

### DETAILED DESCRIPTION OF THE INVENTION

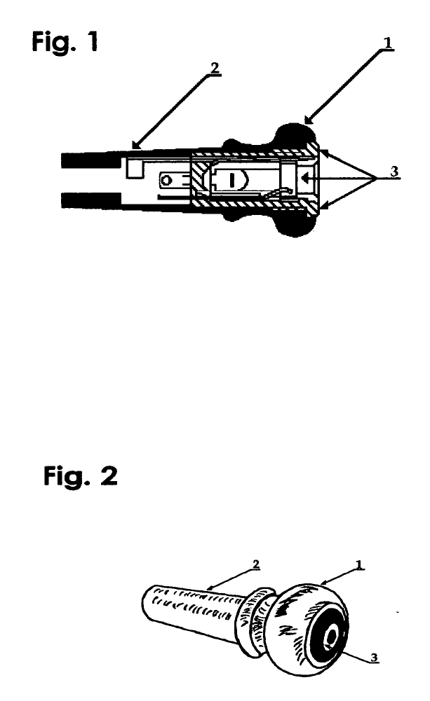

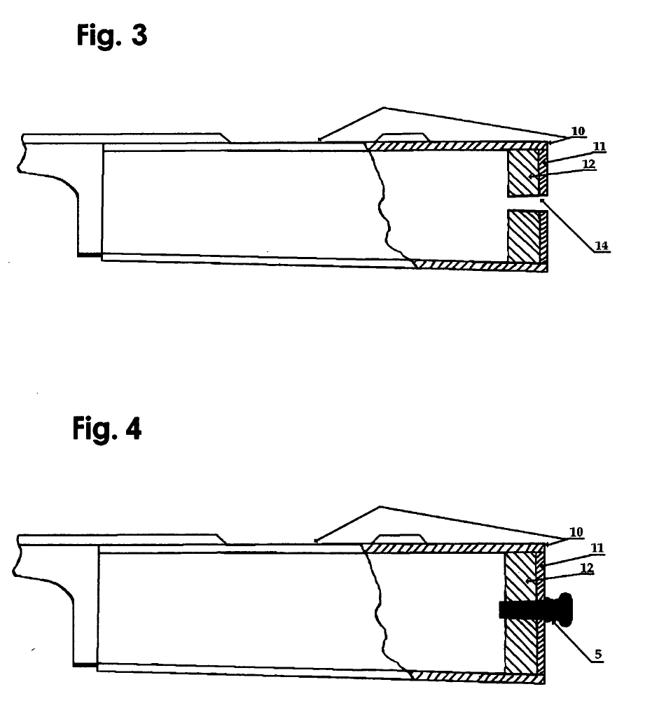

The combination end pin and output jack as shown in FIG. 1 and FIG. 2 may be manufactured of any suitably rigid or semi-rigid material that will allow the inclusion of the necessary components for the electrical jack type connections 3 of FIG. 1 and FIG. 2. The embodiment shown in the drawings is made up of a housing 1 and 2 of FIG. 1 and FIG. 2 with the electrical jack components 3 of FIG. 1 and FIG. 2 inserted as a separate assembly. The housing comprises two main parts, a tapered shaft portion 2 of FIG. 1 and FIG. 2 and a button/head portion 1 of FIG. 1 and FIG. 2. The tapered shaft 2 of FIG. 1 and FIG. 2 is made in such a way that the taper size and angle match the size and angle of the tapered endpin hole 14 of FIG. 3 of the instrument 10 of FIG. 3 or FIG. 4. The button/head portion of the housing 1 of FIG. 1 and FIG. 2 is made to a convenient size and shape to contain the electrical jack components 3 of FIG. 1 and FIG. 2 and also to function as a traditional endpin. There are undoubtedly many possible methods of manufacture.

FIG. 4 shows the combination end pin/output jack assembly FIG. 1, FIGS. 2 and 5 of FIG. 4 in a typical installation as may be found on an acoustic guitar 10 of FIG. 3 or FIG. 4. The combination end pin/output jack FIG. 1, FIGS. 2 and 5 of FIG. 4 is inserted and retained in a tapered end pin hole 14 of FIG. 3 as is traditionally found on acoustic guitars, mandolins, violin and many other musical instruments. The method of retention of the illustrated embodiment of a combination end pin/output jack FIG. 1, FIGS. 2 and 5 of FIG. 4 of the present invention is much like that of a locking taper such as is commonly found on metalworking lathes. In other embodiments of the present invention it may be desirable to include other mechanical or passive retention device/s. It should be noted that installation of the illustrated embodiment of the present invention requires no modification to the instrument thereby eliminating loss in intrinsic value and the danger of structural or cosmetic damage to the instrument as is common with prior art embodiments of musical instrument electrical connection jack installations and the alterations to the instruments that they require.

The combination end pin and output jack FIG. 1 and FIG. 2 will perform the traditional duties of both the instrument end pin and the electrical output connection jack.

In the forgoing description and drawings, the present invention is described in connection with one preferred embodiment thereof. Since many variations, modifications and applications will now be obvious to those skilled in the art, it is realized that these variations, modifications and applications may be used without departing from the scope and spirit of the present invention.

What is claimed is:

1. A combination end pin and output jack for musical instruments, especially but not limited to guitar type and violin family instruments, that will mate with and be retained in a tapered hole.

2. The method of using a tapered hole on musical instruments, especially but not limited to guitar type and violin family instruments, to receive and/or retain an electrical output jack assembly or a combination end pin and output jack.
